(19) United States
(12) Patent Application Publication
(10) Pub. No.: US 2012/0161448 A1
(43) Pub. Date: Jun. 28, 2012

(54) Multiple wind turbine power generation system with dynamic orientation mechanism and airflow optimization

(76) Inventors: Samit Ashok Khedekar, Schaumburg, IL (US); Mayura Madan Gandhi, Schaumburg, IL (US); Sanjay Ashok Khedekar, Mumbai (IN)

(21) Appl. No.: 13/337,029

(22) Filed: Dec. 23, 2011

(51) Int. Cl. F03D 9/00

(52) U.S. Cl. 290/55

(57) ABSTRACT

A multiple wind turbine power generation system includes: multiple rotors each with a substantially vertical shaft and multiple blades extending in a radial manner from each of the rotor shafts with a generator operationally coupled to the rotor shafts; a movable structural frame housing multiple rotors and generators mounted within the frame with a design exposing at least a portion of the rotor blades for each of the rotors; an electrical motor mechanism operatively coupled to the frame; with one or more sensors mounted around the frame structure adapted to determine wind speed and direction, where the electrical motor mechanism is coupled with a processor and assists the movement of the frame structure to orient the wind turbine generator system in the direction of the incident wind flow which will provide the maximum wind force for the turning moment of the rotor shafts of each turbine.

### BACKGROUND OF THE INVENTION

A wind turbine power generation systems is used to generate energy by harnessing the force of the wind generated by wind flowing over various types of rotors. Wind turbines generally work by converting kinetic energy of the wind flow into mechanical energy. The wind turns a mechanical device called a rotor that is connected to a generator, where the generator is designed to generate electricity due to the turning motion imparted to the rotor which is then transferred to the input shaft of the electrical power generator.

Wind turbines are inherently inefficient at low wind speeds as the mass of a single rotor takes substantial force to rotate from a standstill and also to overcome the friction and the inertia of the generator coupled to it. Single rotor systems can also be inefficient as the changing wind direction can cause fluctuation in rotational speed due to a drop in wind flow incident on the rotors.

At low wind speeds, the torque imparted by the wind against a single rotor may not be large enough to overcome the turbine and generator's initial resistance to rotation. However, that same wind speed may be powerful enough to maintain the rotational speed of multiple smaller turbines. As a result, a single large turbine might not start rotating at lower wind speeds that would be adequate to produce energy in a system with multiple smaller turbines. Typical wind turbines lose out on the energy that would be generated if they were able to overcome this initial resistance to rotation. Also a smaller turbine would also be more efficient when the wind packet or volume of wind incident on the rotor is less than ideal.

Accordingly, a need exists for a multiple wind turbine power generation system with improved efficiency, particularly a multiple wind turbine power generation system that operates at lower wind speeds and with a lower moment of inertia in individual rotor systems. This multiple wind turbine power generation system will include single or multiple generators arranged within a frame structure which will be used to set-up the individual turbines such that the system works as a singular unit which will produce electrical energy when the wind turbines are coupled to an electrical power generator.

In addition, typical wind turbines have exposed rotors. In case of a vertical rotor assembly, one half side of the rotor is moving in the same direction as the wind flow while the other half of the rotor is moving in the opposite direction with respect to the wind flow. The maximum efficiency of the aerodynamic forces is on the side of the rotor which is moving in the same direction as the wind while the other half of the rotor has to overcome opposing drag force which reduces the efficiency of the rotor.

Therefore, a need exists to provide a multiple wind turbine power generation system that shields the rotor from aerodynamic inefficiencies created by the incident wind pressure against the leeward side of the rotor and increase the rotational force on the windward side. The structure housing will be designed to improve the wind flow incident on the side of the rotor which is moving in the same direction as the wind and reduce the backpressure on the side that is moving against the direction of the wind which will increase the aerodynamic efficiency of the individual rotors. The frame structure will include aerodynamic devices for each rotor to increase the effect of the wind flow on the individual rotors.

In addition, the wind flow can change direction over the course of time as it occurs in a naturally occurring weather environment and there is a need to orient the entire assembly or system, in the direction of the wind in order to get the maximum wind-flow to impact the rotor at the optimum angle which will provide more rotational velocity to the turbine rotors thus increasing the power generated by the multiple wind turbine power generation system.

The multiple wind turbine power generation system will be equipped with a sensor or sensors to detect wind speed and direction and will orient the wind power system by computing the change in the orientation of the multiple wind turbine power generation system that is required and communicating the same to an electrical motor device which will turn the frame structure to face the wind in the optimum manner.

Further, exposed rotors can be a physical hazard. As a result, there is a need for improving the safety of wind turbines, particularly by reducing the danger imposed by the rotor mechanism. The frame housing and the aerodynamic devices mounted on each of the turbine rotors will reduce the exposed area of the rotating vanes thus reducing the physical hazard.

Further vertical wind turbines also suffer from mechanical failure due to inadequate mechanical support to a rotating turbine. The frame housing will provide additional rigidity to the turbines thus reducing mechanical stress on the rotor shaft and bearings.

### SUMMARY OF THE INVENTION

The needs described above are met by the solutions provided herein. The present invention provides a multiple wind turbine power generation system, which converts wind energy into mechanical energy and then into electric power using one or more generators. While primarily described as a multiple wind turbine power generation system, it is understood that fluids other than wind can be used to drive the turbine. The primary embodiment of the multiple wind turbine power system is one or more vertical axis, wind turbines, but it is contemplated that the wind turbine may be oriented in other directions.

The solution provided herein is preferably provided with a multiple wind turbine power generation system with one or more vertical axis wind power turbines used to generate electricity or provide direct power to a mechanical device through a power transfer mechanism. Within the system, multiple rotor assemblies, where each rotor with multiple blades is mounted on individual shafts with bearing mounts with a power transfer mechanism consisting of a gear (or multiple gears), which drives the power generator or a mechanical and electrical power generation device. A movable frame structure houses the turbine rotors with an aerodynamically shaped device mounted coaxially about each of the turbine rotors. The aerodynamically shaped device will be fixed to the frame structure. Each of the turbine rotors will be mounted in parallel in the frame housing with bearing assemblies to allow for free rotation. The wind turbine rotors will be mounted such that there will be no interference between each of the wind turbine rotors. The shape and structure of the frame housing can be varied to allow for multiple rotors and by aesthetical considerations.

A wind-sensing device is set-up in the vicinity or within the frame structure such that the unhindered wind flow information is captured to sense wind direction and speed. This sensor transmits the wind speed and direction information to a controlling device. The controlling device will store the current orientation of the frame structure and compare it with the wind speed and direction information communicated by the sensor. If the orientation of the frame housing with respect to the wind flow is not optimum per the design of the system, the controlling device will calculate the change in orientation that is required of the frame structure. The controlling device thus includes intelligent decision-making capabilities and signals the electrical motor device to rotate the frame structure about a central pivot point on the base mount. The electrical motor device is powered by a reserve power source, which may be charged by the power generator in the system. A part of the output power of the generator will be used to charge or provide power to the reserve power source to replenish the power source when it is drained or when the reserve power level falls below a predetermined level. The control device may determine the charging schedule of the reserve power source.

The controlling device will also include decision making capabilities to stop the power flow from the generator to the output location if the power generation is above or below a certain threshold value, the power flow from the generator will be switched off to prevent overloading the system and will also include decision making capabilities to actuate a locking mechanism to prevent the frame structure from moving during strong wind gusts and when the entire system is switched off and power production has to be ceased.

The present invention, therefore, has the objective of providing a multiple wind turbine power generation system having improved starting and operating efficiency other existing turbine systems.

The invention has the further objective of providing a turbine which operates efficiently over a wide range of air or fluid flow rates including lower wind speeds and can operate at optimum efficiency with naturally occurring changes in wind direction, and which therefore is suitable for use where the incoming fluid flow varies randomly and wind direction is varied.

The invention therefore also has the objective of providing improved rotational characteristics to the individual turbine rotor thus facilitating continuous generation of power at lower wind speeds.

The invention therefore has the objective of making it more feasible to produce electricity using wind power.

The invention is an improvement to a standard turbine, particularly in improving power generating efficiency at times when the wind changes direction or the wind speed drops as it occurs naturally due to weather patterns.

The present subject matter provides a multiple wind turbine power generation system in which the individual turbine rotor will drive a coupled power generator with a reduced moment of inertia thus allowing for higher operating efficiencies.

The present disclosure also provides a wind turbine power generator system with an improved efficiency turbine by improving the aerodynamic efficiency of the individual turbine rotor system by reducing the pressure of the wind on the leeward side, or reducing the incident wind flow on the part of the turbine rotor or blades where drag is induced, which otherwise would cause the turbine to slow down or lose rotational velocity. A pressure differential will be generated between the sides of the rotor, the first side, which is exposed to the wind, and the second side, which is encased. This pressure differential will be directly incident on the blades of the rotor thus causing the rotor to spin at a higher speed than conventional turbines.

The combination of these improvements increases the operational range of the multiple wind turbine power generation system by the virtue of lower wind speeds required to start the turbine and maintain the rotational speed of the turbine at lower speeds when compared to conventional wind power generator systems. The higher rotational speed caused by the improvement of the aerodynamic efficiency of the individual turbine rotors mounted within the frame housing will mean more mechanical power, thus generating more electrical energy.

Additionally, most wind turbines need to be mounted at a height to afford clearance for the rotating blades to ensure safety and gain from the higher wind speeds at higher relative altitudes. However, with the design presented herein, the turbine assembly and generator can be mounted at a lower height, including rooftops and on other civil structures with similar elevation. Also, with respect to the preferred embodiment, the vertical axis design also allows for mounting the assembly in spaces where the side-to-side clearance required will be less than the clearance required for a horizontal axis wind turbine.

Most multiple wind turbine power generation systems also pose a risk to the flying species due to the exposed rotating vanes, but this vertical axis wind system reduces the risk, as the blades will be partially enclosed and the general layout of the blades and the rotor will reduce the dangerous exposed areas when compared to a typical wind turbine.

This system will also have a reduced noise pollution effect as the rotating vanes or blades will be encased and arranged to provide a streamlined air-flow around the blades thus reducing the interference effect on the wind flow. The multiple rotors will also be supported by a frame which will provide adequate support to both the ends of the rotor with a bearing mechanism thus facilitating reduced bending and torsional and other mechanical stress load on the shaft, which will increase the life of the rotors, reducing the potential to fail and thus increase the life of the wind turbine.

This mechanism and control process can be used for multiple rotor shafts with different layouts.

In one example, a multiple wind turbine power generation system consists of one or more rotor assembly affixed to a substantially vertical rotor shaft supported by bearings, the rotor assembly includes blades mounted where the shaft is housed in a bearing mechanism where the shaft rotates and provides mechanical rotational power by direct mechanical linkage to drive an electrical generator. The rotor assembly is partially enclosed in an aerodynamically efficient wind splitter device which is affixed to the frame structure which reduces the drag or opposing forces on the turning rotor and blade assembly and increases the rotational force on the blades due to the formation of a pressure differential.

A wind direction and speed sensing device is provided, which signals an electrical motor device to move the frame structure which houses the rotors to provide controlled wind flow to the blades of each of the rotors. The control mechanism operationally coupled to the processor, wherein the one or more sensors are further adapted to determine wind direction, further wherein the control mechanism receives a control signal from the processor to rotate the frame structure based on wind direction as determined by the one or more sensors. The processor may provide a control signal to the generator motor mechanism to restrict the rotation of the rotor shaft when the wind speed is above a predetermined speed. The wind turbine may include a reserve power supply operatively coupled to the motor mechanism. The reserve power supply may be controlled by the processor to recharge based on a charging schedule provided by the processor and the charging schedule may be based on wind speed determined by the one or more sensors.

These arrangements are especially useful in harnessing wind power when the wind speed is low.

An advantage of the wind turbine presented herein is higher efficiency at lower wind speeds.

Another advantage of the wind turbine presented herein is improved efficiencies with naturally occurring changing wind directions.

A further advantage of the wind turbine presented herein is an increased operational range of power generation with varying wind speeds.

Yet another advantage of the wind turbine presented herein is a reduced potential for causing injury to living species from exposed rotor blades.

Still another advantage of the wind turbine presented herein is a reduction in operating noise thus reducing noise pollution.

Moreover, it is an advantage of the wind turbine presented herein that the rotor shafts are adequately supported at both ends and mounted appropriate bearing assemblies thus reducing mechanical wear and tear thus increasing the life of the wind power generation system and reducing maintenance requirements over the life of the system.

Additional objects, advantages and novel features of the wind turbine will be set forth in part in the description which follows, and in part will become apparent to those skilled in the art upon examination of the following description and the accompanying drawings or may be learned by production or operation of the examples. The objects and advantages of the concepts and solutions provided herein may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a front sectional elevation perspective view of an example of a multiple wind turbine power generation system.

FIG. 2 is another front sectional elevation perspective view of the multiple wind turbine generation from FIG. 1.

FIG. 3 is a top perspective view of the multiple wind turbine power generation system from FIG. 1.

FIG. 4 is a top sectional perspective view of the blades and rotor of the multiple wind turbine power generation system from FIG. 1.

FIG. 5 is a side perspective view of the wind turbine generator system from FIG. 1.

FIG. 6 is another perspective view of the multiple wind turbine power generation system.

FIG. 7 is a perspective view of another example of the multiple wind turbine power generation system, illustrating an alternate blade layout.

FIG. 8 is a perspective view of another example of the multiple wind turbine power generation system, illustrating an alternate frame structure design.

### DETAILED DESCRIPTION OF THE INVENTION

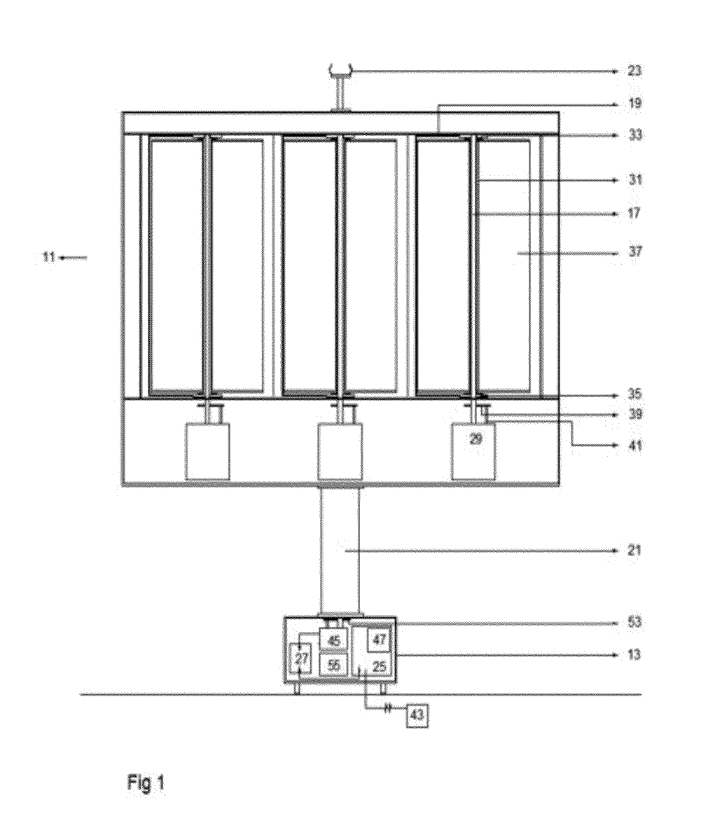

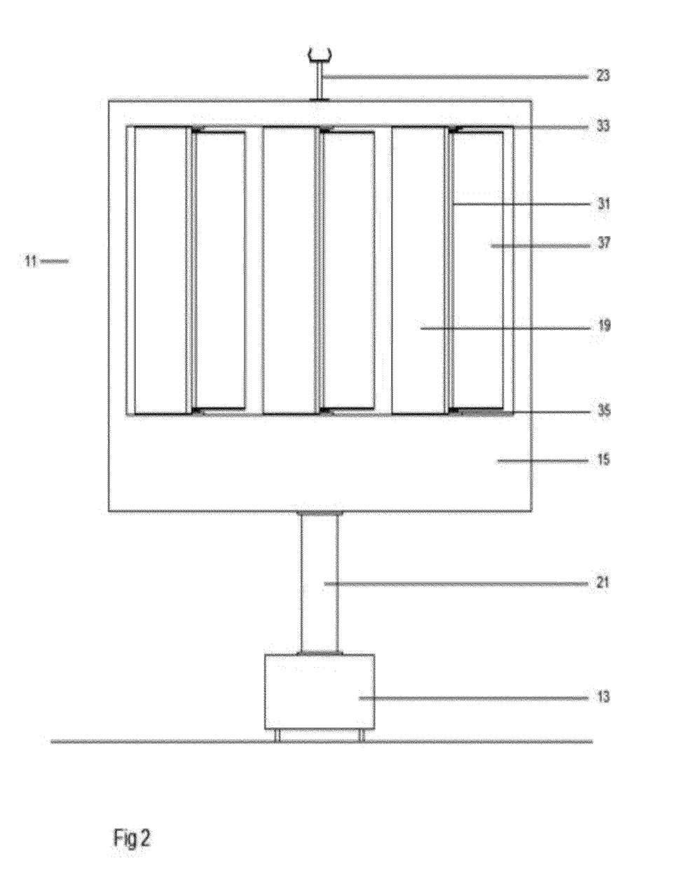

Referring now to the drawings and particularly to FIGS. 1 and 2, a multiple wind turbine power generation system 11 is shown. In use, the multiple wind turbine power generation system 11 is typically mounted on a surface with adequate strength to hold the weight of the multiple wind turbine power generation system 11 and withstand the mechanical loads caused by rotation of the individual turbines, the wind force on the system and the vibration forces that might be caused due to the rotation of the turbines and the system. As shown, the preferred orientation of the multiple wind turbine power generation system 11 is a vertical placement.

As shown, a base 13 supports the frame structure 15, multiple rotor assemblies 17, a wind flow optimization or wind splitter device 19 and a central support 21. In the example shown, the central support 21 is mounted on the frame structure 15 and is stationary. The central support structure 21 supports an anemometer 23. The anemometer 23 is operatively connected to a control device 25 and a reserve power source 27. The control device 25 controls the operation of the anemometer 23 and the reserve power source 27 is used to operate electrical functionality within the multiple wind turbine power generation system 11 when the power generated by the operation of the electrical power generators 29 does not support the operation of the electrical functions. Further, the control device 25 and reserve power source 27 may be used to pass a charge to the anemometer 23 to heat the anemometer 23 to operate in weather conditions where the temperature is below a predetermined threshold level. It is contemplated that in certain embodiments, the reserve power source 27 may increase or decrease the power delivered to the control device 25 to support necessary functions. For example, the power flow level may be increased at fixed intervals as calculated by the control device 25, when the wind speed and direction information is to be checked by the anemometer 23.

The control device 25, reserve electrical power source 27 and electrical motor device 45 to orient the frame structure 15 may be installed or mounted within the base 13

As further shown in FIG. 1, each of the wind turbines 17 consist of a rotor shaft 31 and includes a top thrust bearing 33 and supported by a bottom thrust bearing 35. The turbine rotor shaft 31 is mounted in the frame structure 15 with additional support from the thrust bearings 33 and 35. The turbine rotor shaft 31 includes numerous blades 37 depending therefrom. The turbine blades 37 are disposed in a radial manner with a design intended to increase the aerodynamic efficiency of the turbine, capture the maximum amount of kinetic energy from the wind flow and reduce the chop generated by the rotation of the turbine rotors.

The wind turbine rotor assembly 17 is thus formed of multiple wind turbines with individual turbine rotor shafts 31 and multiple blades 37 attached to the individual rotor shaft 31. In use, the wind will be incident on the turbine blades 37, thus producing rotational force. The turbine rotor assembly 17 with an individual top thrust bearing 33 and bottom thrust bearing 35 for each of the turbine rotors 17, which allows for generally free rotation. The shape and design of the turbine blades 37 may be streamlined to reduce drag and increase the rotational power provided to the turbine rotor shaft 31, as will be understood by a person skilled in the art in light of the disclosure provided herein.

As further shown, a power transfer mechanism 39 is attached to the turbine rotor shaft 31 to transmit power to a follower mechanism by gearing or a belt and pulley mechanism. The mechanical power is transferred to a generator input shaft 41 of an electric power generator 29. It will be clear to a person skilled in the art that the power transfer mechanism 39 may be embodied in many varied forms including, but not limited to, direct-drive gears and multiple gears arrangements.

An electrical drive motor 45 is provided to rotate the frame structure 15 around the vertical axis of the multiple wind turbine power generation system 11, as described further herein.

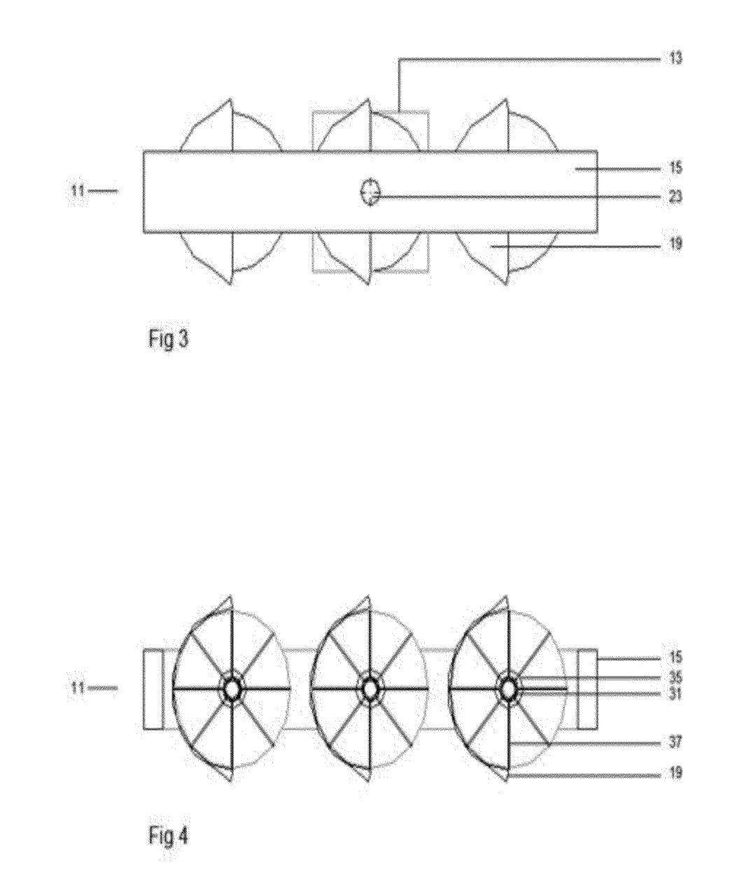

Referring now to FIG. 3, the anemometer 23 is mounted clear of any obstacles and in a location where it can measure the undisturbed wind speed and direction. The wind speed and direction information is transmitted to the control device 25 located in the base 13. The control device 25 includes logical algorithms included in the central processing unit 47 to calculate whether the multiple wind turbine power generation system 11 is working at the optimal efficiency. The control device 25 may further transmit signals to an electrical drive motor 45 to reorient the frame structure 15, as required. The frame structure 15 is shaped to reduce drag forces and provide for smooth airflow around the turbine blades 37 by the effective use of the wind flow optimization device or wind splitter 19 affixed to the frame structure 15 thus reducing the vortex generation around the turbine blades 37 and increasing the direct force on the exposed turbine blades 37 in FIG. 3 and FIG. 4.

The anemometer 23 also communicates with the control device 25 to transmit the wind speed and direction in an electrical code to be deciphered by the control device 25 to accurately compute the data. The anemometer 23 data is then captured and converted by the control device 23 using logical algorithms built in to the central processing unit 47 within the control device 23 to check the wind speed to make sure any extraneous information like sudden or quick change in wind direction or wind gusts are to be included and is accounted for when calculating the required or desired orientation of the frame structure 15 and the multiple wind turbine power generation system 11 in general. The control device 23, the electrical drive motor 45 and anemometer 23 are powered by the reserve power source 27 when required. The flow of power to the control device 23, the electrical drive motor 45 and anemometer 23 is monitored and controlled by the control device 23 which will include logical algorithms to decide on the activation or deactivation of these devices.

Referring now to FIGS. 1, the control device 25 compares the wind speed and the rotational speed of the turbine rotors 17 to ascertain whether the multiple wind turbine power generation system 11 is working as designed at its optimum level and will move or orient the frame structure 15 via the electrical drive motor 45 at regular intervals to the calculated optimal position. When the frame structure 15 should be moved the electrical drive motor 45 rotates the housing 15 via the power transfer mechanism 53 and then locks and holds the frame structure 15 in the desired position with an electro-mechanical locking mechanism 55 to prevent the frame structure 15 from moving or rotating due to the wind or other forces incident on it. The locking mechanism 55 is controlled by the controlling device 25 and the central processing unit based on logical algorithms and is actuated based on a signal from the controlling device 25. The locking and unlocking process may be synchronized with the rotational movement of the frame structure 15 to ensure that it is oriented in the optimum direction with respect to the wind flow at any given time.

The control device 25 will signal the locking mechanism 55 t to allow the frame structure 15 to be rotated. The frame structure 15 can be rotated or moved only when the locking mechanism 55 is disengaged and the locking mechanism 55 will be reactivated to prevent the frame structure 15 from moving after the frame structure is oriented in the required direction. The control device 25 may be programmed to derive the wind speed and direction information at a fixed predetermined interval and store this information to be retrievable by electronic data processing aid and may be activated at fixed intervals by the central processing unit 47.

The control device 25 may also check the reserve power source 27 to ascertain whether it has sufficient power reserve or electrical power available to power the anemometer 23, control device 25 with the central processing unit 47 and the electrical drive motor 45. If the power level available in the reserve electrical power source 27 falls below a certain threshold value, the control device 25 may divert power from the electrical power generator 29 via a switch or a similar device. When the power level in the reserve power source 27 is greater than a predetermined value, the flow of power to the reserve power source 27 will be cut-off and the power generated by the generator will flow to the power output circuit 57. The control device 25 may be programmed to check the available electrical power parameters in the reserve power source 27 at a fixed predetermined interval and store this information to be retrievable by electronic data processing aid. The electrical devices and switches that may be used to charge the reserve power source 27 are also included in the multiple wind turbine power generation system 11. These electrical switches and components are generally known to one skilled in the art and thus will not be discussed further.

The control device 25 could also monitor the wind speed and direction information transmitted by the anemometer 23 and compare the rotational speed of the individual turbine rotors 17 to determine whether the wind speed is higher than a threshold value. If the rotational speed is above the threshold, the control device 25 may decide the turbine rotors 17 should not be in motion. If the control device 25 completes the check and the turbine rotors 17 are in motion at a speed greater than the predetermined threshold, the control device 25 may close the switch for the power flow from the electrical power generator 29 to avoid damage to the generator 29. If the speed of the wind is above a certain predetermined threshold level, then the control device 25 will also signal the reserve power source 27 to switch the power flow to the generator braking system to clamp or lock the generator shaft 41 from turning, thus preventing the turbine rotor 17 from turning. The electrical devices and components, which will switch the flow of power from the electrical power generator 29 are generally known to one skilled in the art and thus will not be discussed further.

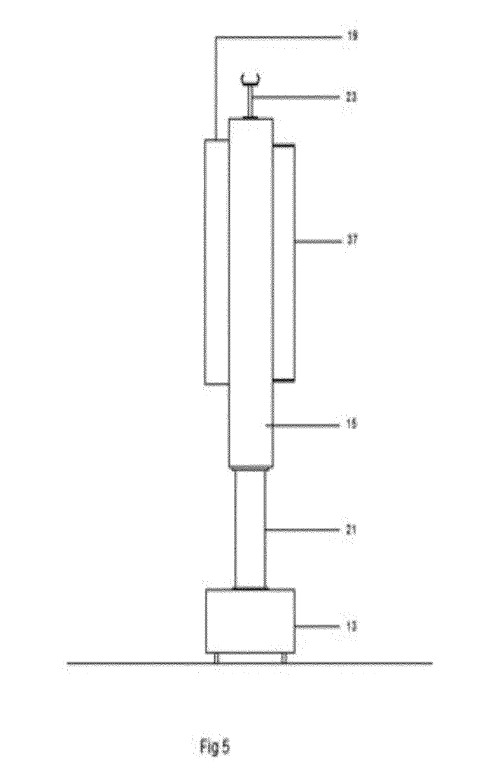

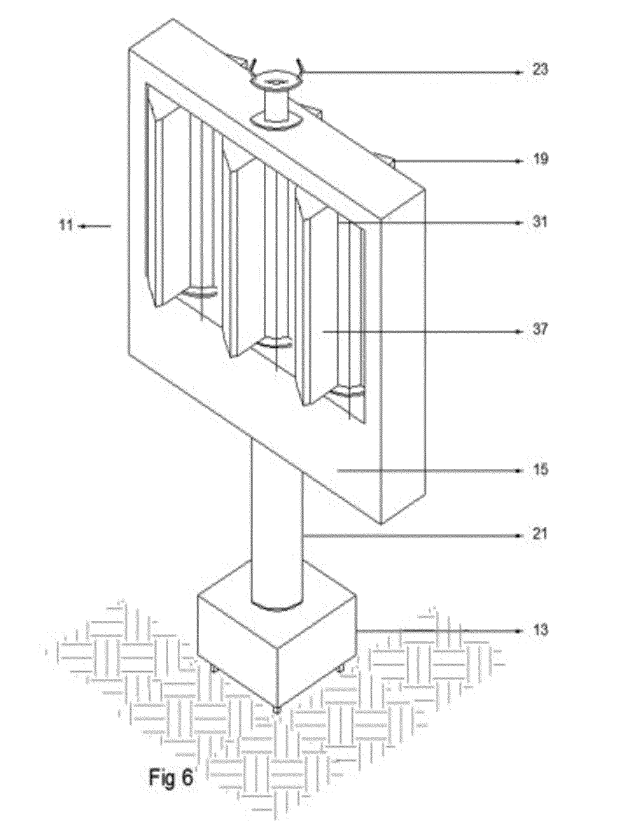

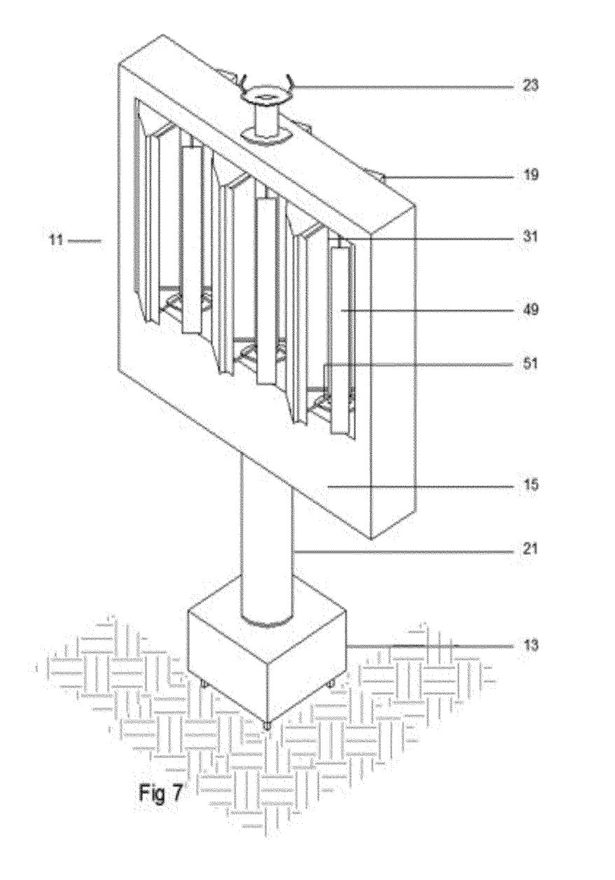

FIG. 5 and FIG. 6 illustrates the general set-up of the multiple wind turbine power generation system where the base 13 will be mounted on a flat surface of adequate strength with the exposed rotor blades 37 directly facing the wind.

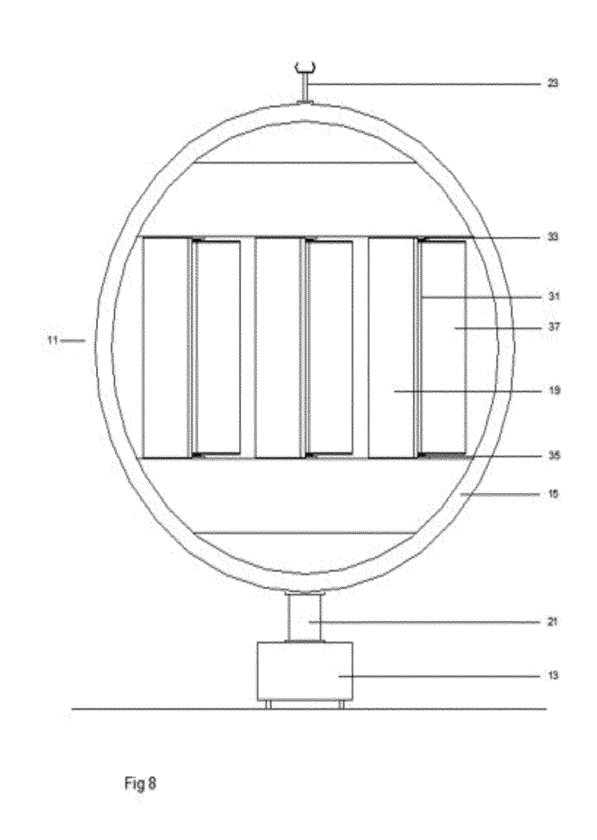

FIG. 7 illustrates an alternate embodiment of the multiple wind turbine power generation system 11 and is provided to describe an example of alternate rotor layouts with lift type rotor blades 49. With this layout, the multiple wind turbine power generation system 11 will have the same layout and schema as the embodiment described with respect to FIGS. 1-5, but the layout and type of turbine blades 37 used in the individual turbine rotors of the multiple wind turbine power generation system 11 will be visibly different. As shown, the turbine blades 37 will be shaped like an aerofoil that is oriented in a circumferential direction and the blades 37 are attached to the turbine rotor shaft 31 by horizontal supports 51.

FIG. 8 illustrates an alternate embodiment of the multiple wind turbine power generation system where the shape of the frame structure is varied to be aesthetically harmonious with the installation location and requirements of the customer. The working operation and design of the multiple wind turbine power generation system will also be varied to work with the design of the frame structure but will have the same general layout and schema as the embodiment described in FIGS. 1-5.

The above description embodies the general spirit of the invention and the schematic relationships for the parts of the invention, to include variations in size, schema, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, various changes in layout, size, shape and structure and departures may be made to the invention without departing from the spirit and scope thereof. Thus it is not intended that the invention be limited to what is described in the specification and illustrated in the drawings, rather only as set forth in the claims.

We claim:

1. A multiple wind turbine power generation system comprising:
Multiple rotors with a substantially vertical shaft and plurality of blades radially extending from the shaft, wherein the individual rotors are arranged in a symmetrical manner;
a frame structure housing the above mentioned rotors where the frame structure can be rotated about a central pivot point;
an aerodynamically efficient wind flow optimization or wind splitter device affixed to the frame arranged around each of the rotors;
a generator operationally coupled to the rotor shafts;
an electrical drive motor mechanism operatively coupled to the frame structure;
one or more sensors adapted to determine wind speed;
a processor operatively coupled to the one or more sensors and the electrical motor mechanism, wherein, in reaction to input received from the one or more sensors, the processor provides a control signal to the electrical drive motor mechanism to assist the change in the orientation of the frame when a change in wind direction occurs to optimize the wind flow angle incident on the rotors.

2. The multiple wind turbine power generation system of claim 1 wherein the aerodynamically efficient wind flow optimization or wind splitter device housing reduces drag on the side of the rotor which is moving against the direction of the wind and provide additional rotational force on the side of the rotor which is moving in the same direction as the wind flow, due to a pressure differential effect from the wind flow optimization.

3. The multiple wind turbine power generation system of claim 1 wherein the arrangement of multiple smaller rotors than one single larger rotor will provide for lower moment of inertia and higher efficiencies at lower wind speeds.

4. The multiple wind turbine power generation system of claim 1 wherein the processor provides a control signal to the electrical motor mechanism to restrict the rotation of the rotor shafts when the wind speed is above a predetermined speed to avoid damage to the system or below a certain speed when producing power will not be efficient.

5. The multiple wind turbine power generation system of claim 1 will have a longer operational life and lower maintenance required as each of the rotors will be housed in adequate bearings on both ends of the shafts, thus reducing bending stresses.

6. The multiple wind turbine power generation system of claim 1 further including a reserve power supply operatively coupled to the electrical motor drive mechanism which will be used to orient the frame structure as and when required.

7. The multiple wind turbine power generation system of claim 5 wherein the reserve power supply is controlled by the processor to recharge based on a charging schedule which is programmed in the processor.

8. The multiple wind turbine power generation system of claim 6 wherein the charging schedule for the reserve power supply is based on wind speed determined by the one or more sensors.
